(19) United States
(12) Patent Application Publication
(10) Pub. No.: US 2012/0105413 A1
(43) Pub. Date: May 3, 2012

(54) FLAT PANEL DISPLAY APPARATUS AND METHOD OF MANUFACTURING FLAT PANEL DISPLAY APPARATUS

(75) Inventors: Oh-Seob Kwon, Yongin-city (KR); Sung-Soo Koh, Yongin-city (KR); Dong-Seop Park, Yongin-city (KR); Jae-Sang Ro, Seoul (KR); Seog-Young Lee, Seoul (KR); Won-Eui Hong, Seoul (KR)

(73) Assignees: Ensil Tech Co., Ltd., Seoul (KR); Samsung Mobile Display Co., Ltd., Yongin-city (KR)

(21) Appl. No.: 13/238,948

(22) Filed: Sep. 21, 2011

(30) Foreign Application Priority Data
Oct. 27, 2010 (KR) 10-2010-0105373

(51) Int. Cl. G09G 5/00

(52) U.S. Cl. 345/211

(57) ABSTRACT

A flat panel display apparatus includes a substrate, a display unit on the substrate, a sealing substrate facing the display unit, a sealing member between the substrate and the sealing substrate surrounding the display unit, a wiring unit between the substrate and the sealing substrate with an area overlapped with the sealing member, the wiring unit comprising a plurality of separate wiring members, and a leading unit comprising a main body unit, a connection unit, and an intermediate unit that are integrally formed and where the leading unit is configured to receive a voltage applied to the wiring unit from an external power source. The connection unit is connected to the wiring unit, the main body unit is connected to the external power source, the intermediate unit is arranged between the connection unit and the main body unit, and a width of the connection unit decreases away from the main body unit.

### CROSS-REFERENCE TO RELATED APPLICATIONS

This application claims the benefit of Korean Patent Application No. 10-2010-0105373, filed on Oct. 27, 2010, in the Korean Intellectual Property Office, the disclosure of which is incorporated herein in its entirety by reference.

### BACKGROUND

1. Field

The present disclosure relates to a flat panel display apparatus and a method of manufacturing a flat panel display apparatus, and more particularly, to a flat panel display apparatus having an improved encapsulation characteristic, and a method of manufacturing a flat panel display apparatus.

2. Description of the Related Technology

Recently, display apparatuses are being substituted by portable, thin flat panel display apparatuses. In particular, flat panel display apparatuses, such as organic light emitting display apparatuses and liquid crystal display apparatuses, are highlighted due to their superior image quality.

In a flat panel display apparatus, a display unit is arranged on a substrate and a sealing substrate is arranged above the display unit to protect the display unit. Also, a sealing member is arranged between the substrate and the sealing substrate to seal the flat panel display apparatus.

The flat panel display apparatus undergoes an encapsulation process to protect the display unit from external moisture, gas, and other foreign materials. The quality of the flat panel display apparatus is greatly affected by an encapsulation characteristic.

The encapsulation characteristic is dominated by the sealing substrate and sealing member. A uniform sealing characteristic of the sealing member is quite important. However, there is a limit in improving the encapsulation characteristic because a process of forming a sealing member is not easy.

### SUMMARY OF CERTAIN INVENTIVE ASPECTS

To solve the above and/or other problems, embodiments of the present invention provide a flat panel display apparatus which may easily improve an encapsulation characteristic, and a method of manufacturing a flat panel display apparatus.

According to one aspect, a flat panel display apparatus includes a substrate, a display unit on the substrate, a sealing substrate facing the display unit, a sealing member between the substrate and the sealing substrate surrounding the display unit, a wiring unit between the substrate and the sealing substrate with an area overlapped with the sealing member, the wiring unit comprising a plurality of separate wiring members, and a leading unit including a main body unit, a connection unit, and an intermediate unit that are integrally formed and where the leading unit is configured to receive a voltage applied to the wiring unit from an external power source, wherein the connection unit is connected to the wiring unit, the main body unit is connected to the external power source, the intermediate unit is arranged between the connection unit and the main body unit, and a width of the connection unit decreases away from the main body unit.

A width of an end of the connection unit contacting the intermediate unit may be greater than a width of the wiring unit and less than a width of the main body unit.

The main body unit may have a width greater than a width of the wiring unit.

The main body unit may be located farthest from the display unit in an area of the leading unit.

The connection unit may have an area overlapped with the sealing member.

The intermediate unit may have a width that gradually decreases from an end contacting the main body unit towards an end contacting the connection unit.

The intermediate unit may include a first intermediate unit contacting the main body unit and a second intermediate unit contacting the connection unit, and the first intermediate unit has a width that gradually decreases from an end contacting the main body unit towards an end contacting the second intermediate unit.

The second intermediate unit may meet the outermost area of the wiring unit, and an angle between the second intermediate unit and the outermost area of the wiring unit is a right angle, or an obtuse angle.

The plurality of separate wiring members may be separated from one another in a widthwise direction of the sealing member.

The leading unit may be formed along two opposing sides of the substrate.

The leading unit may be formed to along two opposite corners of the substrate.

The plurality of separate wiring members may be formed on the substrate and the sealing member may be arranged on the plurality of separate wiring members in a space between neighboring wiring members.

The plurality of separate wiring members may include wiring members with curved corner portions.

The sealing member may include frit.

The display unit may include an organic light emitting device, or a liquid crystal display device.

According to another aspect, a method of a flat panel display unit includes preparing a substrate on which a display unit is arranged, providing a sealing substrate to face the display unit, forming a sealing member surrounding the display unit between the substrate and the sealing substrate, forming a wiring unit comprising a plurality of separate wiring members, and comprising an area overlapped with the sealing member between the substrate and the sealing substrate, and forming an integrally formed leading unit electrically connected to an external power source, and comprising a main body unit, a connection unit, and an intermediate unit, wherein the connection unit is connected to the wiring unit, the main body unit is connected to the external power source, the intermediate unit is arranged between the connection unit and the main body unit, and a width of the connection unit decreases away from the main body unit, and wherein the forming of the sealing member comprises arranging a material for forming the sealing member between the substrate and the sealing substrate, electrically connecting the external power source to the main body unit, applying a voltage to the wiring unit from the external power source, melting and curing the material for forming the sealing member by using heat generated in the wiring unit.

The sealing member may include frit.

### BRIEF DESCRIPTION OF THE DRAWINGS

The above and other features and advantages will become more apparent by describing certain embodiments with reference to the attached drawings in which:

FIG. 1 is a schematic plan view of an embodiment of a flat panel display apparatus;

FIG. 2 is a cross-sectional view taken along line II-II of FIG. 1;

FIG. 3 is an enlarged view of portion A of FIG. 1;

FIG. 4 is an enlarged view of portion X of FIG. 2;

FIG. 5 is a schematic plan view illustrating forming a sealing member in an embodiment of a process of manufacturing an embodiment of the flat panel display apparatus of FIG. 1;

FIG. 6 is a schematic plan view of another embodiment of a flat panel display apparatus;

FIG. 7 is an enlarged view of a portion B of FIG. 6; and

FIG. 8 is a schematic plan view of another embodiment of a flat panel display apparatus.

### DETAILED DESCRIPTION OF CERTAIN INVENTIVE EMBODIMENTS

The attached drawings for illustrating certain embodiments are referred to in order to gain an understanding of the present invention, the merits thereof, and the objectives accomplished by the implementation of the present invention. Hereinafter, the present invention will be described by explaining certain embodiments with reference to the attached drawings. Like reference numerals in the drawings generally denote like elements.

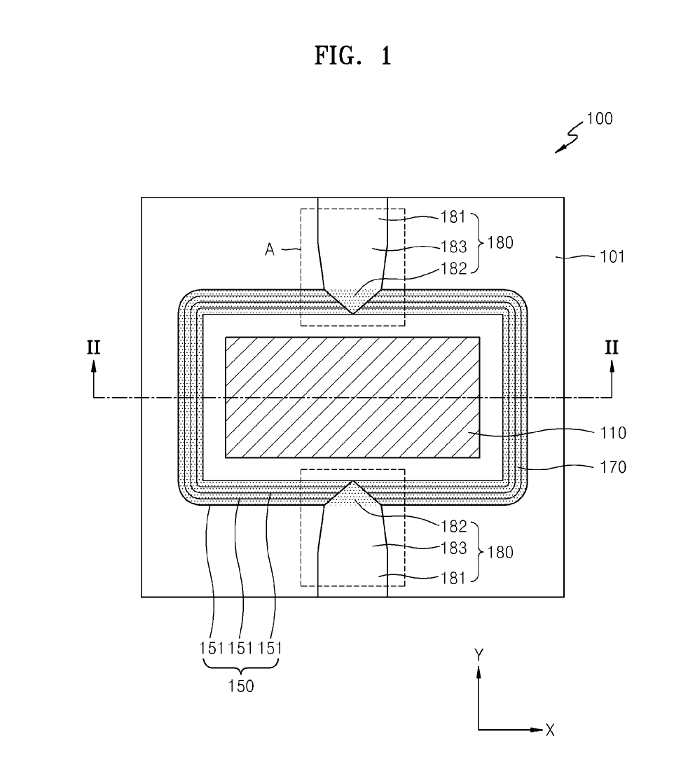

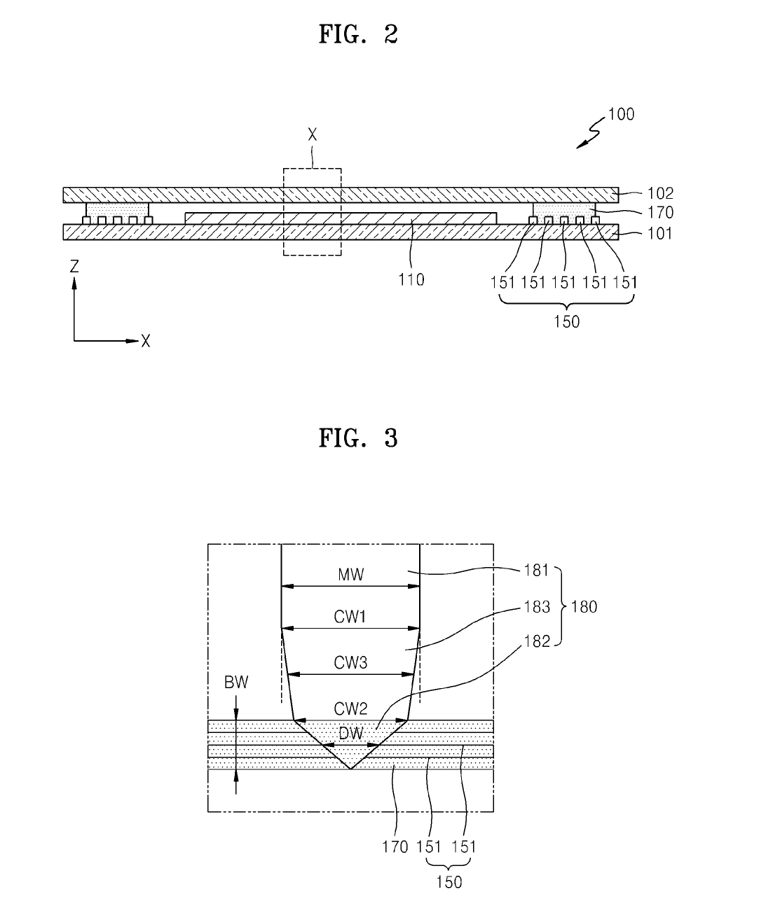

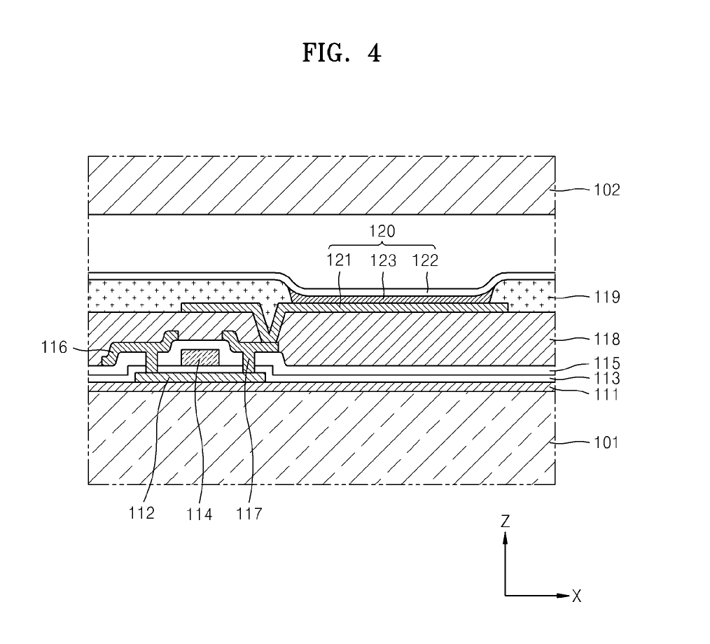

FIG. 1 is a schematic plan view of an embodiment of a flat panel display apparatus 100. FIG. 2 is a cross-sectional view taken along line II-II of FIG. 1. FIG. 3 is an enlarged view of portion A of FIG. 1. FIG. 4 is an enlarged view of portion X of FIG. 2.

In FIG. 1, for convenience of explanation, a sealing substrate 102 is not illustrated. Also, for convenience of explanation, a sealing member 170 is indicated as a dotted area in FIG. 1.

Referring to FIGS. 1-4, the flat panel display apparatus 100 includes a substrate 101, a display unit 110, the sealing substrate 102 (not shown), a wiring unit 150, the sealing member 170, and a leading unit 180. The wiring unit 150 includes a plurality of wiring members 151. The leading unit 180 includes a main body unit 181, a connection unit 182, and an intermediate unit 183. The substrate 101 may be formed of a transparent glass material containing SiO₂ as a main ingredient. In other embodiments, the substrate 101 may be formed of a transparent plastic material. The transparent plastic material forming the substrate 101 may be an organic substance selected from polyethersulphone (PES), polyarcrylate (PAR), polyetherimide (PEI), polyethyelenen napthalate (PEN), polyetheleneterepthalate (PET), polyphenylene sulfide (PPS), polyallylate, polyimide, polycarbonate (PC), triacetyl cellulose (TAC), and cellulose acetate propionate (CAP).

The display unit 110 is arranged on the substrate 101. The display unit 110 may have a variety of shapes. In some embodiments, the display unit 110 includes an organic light emitting device. In other embodiments, the display unit 110 may include a liquid crystal device.

The sealing substrate 102 (not shown) is arranged facing the display unit 110. The sealing member 170 is arranged between the substrate 101 and the sealing substrate 102. The sealing member 170 surrounds the display unit 110. The sealing member 170 facilitates coupling between the substrate 101 and the sealing substrate 102. In some embodiments, the sealing member 170 may include frit.

The wiring unit 150 is overlapped with the sealing member 170. The wiring unit 150 surrounds the display unit 110. The wiring unit 150 is formed on the substrate 101. The sealing member 170 is formed on the wiring unit 150. The sealing substrate 102 (not shown) is arranged on the sealing member 170.

The wiring unit 150 includes the wiring members 151. The wiring members 151 are separated from one another in an area overlapped with at least the sealing member 170. The wiring members 151 may be arranged to be separated from one another without overlapping each other in the overall area, as illustrated in FIG. 1. The wiring members 151 may be formed using various conductive materials.

The wiring members 151 are arranged on the substrate 101. The sealing member 170 is arranged over the wiring members 151 and in a space between the wiring members 151 that are separated from each other. The sealing substrate 102 (not shown) is arranged on the sealing member 170.

Since the sealing member 170 contacts the substrate 101 through the space between the wiring members 151 that are separated from each other, durability of the sealing member 170, and a coupling characteristic between the substrate 101 and the sealing substrate 102 are improved.

In order to form the sealing member 170, a material for forming the sealing member 170 is arranged and a voltage is applied to the wiring unit 150 from an external power source. When joule heat is generated by the wiring unit 150, the material is melted by the generated heat and then cured so that the sealing member 170 is formed.

If the wiring unit 150 is formed to have a width corresponding to the width of the sealing member 170, when a voltage is applied to the wiring unit 150, the wiring unit 150 is generally heated such that a center portion and a peripheral portion of the wiring unit 150 are irregularly heated. Accordingly, imbalance in the temperature between the center portion and the peripheral portion with respect to the width of the sealing member 170 is likely to be generated. The temperatures of the center portion and the peripheral portion of the sealing member 170 are different from each other with respect to the width of the sealing member 170. Accordingly, during the melting and heating for forming the sealing member 170, the sealing member 170 is irregularly melted and cured so that the durability of the sealing member 170 may be reduced.

In some embodiments disclosed herein, the wiring unit 150 includes the wiring members 151 separated from one another in an area overlapped with the sealing member 170. Since a voltage is applied to each of the wiring members 151 and heat is generated by each of the wiring members 151, the imbalance in the temperature between the center portion and the peripheral portion with respect to the width of the sealing member 170 may be prevented.

In FIG. 1, the wiring unit 150 is shown in a rectangular shape, and it includes four corner portions. When the wiring unit 150 is formed to be an integrated single wiring member, imbalance in the flow of current is generated in the inner and outer sides of the integrated single wiring member at each corner portion, areas of the integrated single wiring member close to and far from the display unit 110. Since a path of current in the inner side of the integrated single wiring member at each corner portion is shorter than a path of current on the outer side thereof, the flow of current concentrates at the inner side of the integrated single wiring member. As such, when a voltage is applied, the amount of heat generated in the inner side of the integrated single wiring member at a corner portion, which is close to the display unit 110, disproportionately increases so that the sealing member 170 is irregularly melted during the application of a voltage.

In embodiments disclosed herein, the wiring unit 150 includes the wiring members 151. Each of the wiring members 151 functions as a separate current path at a corner portion of the wiring unit 150. Accordingly, the irregular current concentration on the inner and outer sides of the wiring unit 150 at a corner portion is not generated. By preventing the concentration of current in the inner side of the wiring unit 150 at a corner portion, current may uniformly flow in the corner portion of the wiring unit 150. As such, the sealing member 170 may be uniformly heated.

In some embodiments, the wiring unit 150 includes the wiring members 151 that are curved, not angled, at a corner portion. Thus, the disproportional application of a voltage to the corner portion of the wiring unit 150 may be more effectively prevented. Although the corner portion of one of the wiring members 151 at the innermost side is illustrated to be angled in FIG. 1, in other embodiments, the corner portions may be formed to be curved. Therefore, the uniform flow of current in the corner portion of the wiring unit 150 may be further facilitated.

The width of the wiring unit 150 may correspond to the width of the sealing member 170 or be slightly smaller or greater than the width of the sealing member 170 according to a process condition.

The leading unit 180 is connected to the wiring unit 150. The leading unit 180 is formed on two opposing sides of the wiring unit 150. The leading unit 180 is formed to correspond to two sides of the substrate 101.

The leading unit 180 includes the main body unit 181, the connection unit 182, and the intermediate unit 183. The connection unit 182 is connected to the wiring members 151. The main body unit 181 is located farthest from the display unit 110 to be connected to an external power source. The intermediate unit 183 is arranged between the main body unit 181 and the connection unit 182. One of the wiring members 151 located farthest from the display unit 110 contacts the connection unit 182 and the intermediate unit 183.

The main body unit 181 has a width MW. The width MW of the main body unit 181 may be greater than a width BW of the wiring unit 150. In some embodiments, the width MW of the main body unit 181 may be greater than a sum of the widths of the wiring members 151. In a process of applying heat for forming the sealing member 170, a voltage is applied to the wiring unit 150. A voltage is applied from an external power source through the main body unit 181. Accordingly, current flows in the wiring unit 150. In embodiments of the wiring unit 150 illustrated in FIG. 1, the current flowing in the area of the wiring unit 150 corresponding the left side of the display unit 110 and the current flowing in the area of the wiring unit 150 corresponding the right side of the display unit 110 meet in the main body unit 181.

A voltage needed to generate heat for melting during the forming of the sealing member 170 is applied to the wiring unit 150. More load is applied to the main body unit 181 than the wiring unit 150 because the current flowing in the area of the wiring unit 150 corresponding to the left side of the display unit 110 and the current flowing in the area of the wiring unit 150 corresponding to the right side of the display unit 110 need to simultaneously flow. The main body unit 181 is wider than the width of the wiring unit 150 so as to prevent generation of excessive heat. When the width of the main body unit 181 is twice greater than the sum of the widths of the wiring members 151, the heat generated by the main body unit 181 and the heat generated by the wiring unit 150 may be similar to each other.

The connection unit 182 is connected to the wiring members 151. The connection unit 182 has a width DW that varies and decreases in a direction away from the main body unit 181. Accordingly, the length of the each of the wiring members 151 may be uniformly controlled. The length of any of the wiring members 151 located far from the display unit 110 is prevented from being greater than the length of any of the wiring members 151 located close to the display unit 110. Thus, a uniform flow of current is generated in the wiring members 151 so that uniform heat is generated in the wiring members 151 during the application of a voltage for forming the sealing member 170. As a result, a uniform characteristic of the sealing member 170 may be obtained.

As illustrated in FIG. 1, the connection unit 182 includes an area overlapped with the sealing member 170. Since the connection unit 182 has a width that gradually decreases, uniform current flows in an area of the connection unit 182 overlapped with the sealing member 170 so that the uniform characteristic of the sealing member 170 may be obtained. The sealing member 170 has a portion overlapped with the wiring unit 150 and a portion overlapped with the connection unit 182. As uniform current flows in the area of the connection unit 182, the sealing member 170 may easily have a uniform characteristic.

Also, a width CW2 of the connection unit 182 that contacts the intermediate unit 183 is greater than the width of the wiring unit 150 and less than the width MW of the main body unit 181. Since the connection unit 182 includes an area overlapped with the sealing member 170, heat needs to be effectively transferred when an external voltage is applied. Since the connection unit 182 is an area connected to the wiring members 151, when a voltage is applied from the external power source, an area where the amount of heat generated is partially lowered is generated. The area may deteriorate the characteristic of the sealing member 170. In some embodiments, by making the width CW2 of an end of the connection unit 182 less than the width MW of the main body unit 181, the amount of heat generated in the connection unit 182 is greater than that of the main body unit 181. Accordingly, heat is effectively transferred to an area of the sealing member 170 that overlaps the connection unit 182, thereby improving the uniform characteristic of the sealing member 170.

Since the connection unit 182 has an integrated structure, when a voltage is applied by the external power source, current stably flows in a whole area of the connection unit 182 overlapped with the sealing member 170 so that the uniform characteristic of the sealing member 170 may be obtained.

The intermediate unit 183 is arranged between the main body unit 181 and the connection unit 182. The width CW1 of an end of the intermediate unit 183 contacting the main body unit 181 is greater than the width CW2 of an end of the intermediate unit 183 contacting the connection unit 182. Also, the intermediate unit 183 has the width CW3 between one end thereof contacting the main body unit 181 and the other end thereof contacting the connection unit 182. The width CW3 decreases away from the main body unit 181 toward the connection unit 182. As the width CW3 of the intermediate unit 183 gradually changes, current flowing from the main body unit 181 to the connection unit 182 is prevented from drastically changing.

The external power source (not shown) may be connected to the main body unit 181 of the leading unit 180. As such, a voltage is applied to the wiring unit 150 from the external power source and thus heat is generated, and the sealing member 170 may be formed using the heat.

In some embodiments, the leading unit 180 may be formed using the same material as the wiring unit 150.

In various embodiments, the display unit 110 may be of a variety of types. In the embodiment shown in FIG. 4, the display unit 110 employs an organic light emitting device. The display unit 110 is hereby described in detail with reference to FIG. 4.

A buffer layer 111 is formed on the substrate 101. The buffer layer 111 may flatten an upper portion of the substrate 101 and prevent moisture and foreign materials from penetrating into the substrate 101.

An active layer 112 of a predetermined pattern is formed on the buffer layer 111. The active layer 112 may be formed of inorganic semiconductor or organic semiconductor, such as amorphous silicon or polysilicon, and include a source region, a drain region, and a channel region.

The source and drain regions may be formed by doping the active layer 112 with foreign materials. A p-type semiconductor and an n-type semiconductor may be formed respectively by doping boron B, which is a Group III element, and nitrogen N, which is a Group V element. Other elements may also be used.

A gate insulation film 113 is formed over the active layer 112. A gate electrode 114 is formed in a predetermined area on an upper surface of the gate insulation film 113. The gate insulation film 113 insulates the gate electrode 114 from the active layer 112 and may be formed of an organic substance or an inorganic substance, such as SiNx or SiO₂.

In some embodiments, the gate electrode 114 may be formed of metal, such as Au, Ag, Cu, Ni, Pt, Pd, Al, or Mo, or an alloy, such as Al:Nd or Mo:W, or a metal alloy. In other embodiments, a variety of materials may be used considering adhesiveness, flatness, electric resistance, and processing ability. The gate electrode 114 is connected to a gate line (not shown) for applying an electric signal.

An interlayer insulation film 115 is formed on the gate electrode 114. The interlayer insulation film 115 and the gate insulation film 113 are formed exposing the source region and the drain region such that a source electrode 116 and a drain electrode 117 respectively contact the exposed source region and the drain regions of the active layer 112.

In some embodiments, a material for forming the source electrode 116 and the drain electrode 117 may be Al, Mo, an Al:Nd alloy, an alloy made of two or more metals, such as a MoW alloy, in addition to Au, Pd, Pt, Ni, Rh, Ru, Ir, and Os. In other embodiments, other materials may be used.

A passivation layer 118 is formed covering the source electrode 116 and the drain electrode 117. An inorganic insulation film and/or an organic insulation film may be used as the passivation layer 118. An inorganic insulation film may include SiO₂, SiNx, SiON, Al₂O₃, TiO₂, Ta₂O₅, HfO₂, ZrO₂, BST, and PZT. An organic insulation film may include a general polymer (PMMA or PS), a polymer derivative having a phenol group, an acrylic polymer, an imide-based polymer, an aryl ether-based polymer, an amide-based polymer, a fluorine-based polymer, a p-xylene-based polymer, a vinyl alcohol-based polymer, and blends thereof. In some embodiments, the passivation layer 118 may be formed of a combined stack of an inorganic insulation film and an organic insulation film.

The passivation layer 118 exposes the drain electrode 117. An organic light emitting device 120 is connected to the exposed drain electrode 117. The organic light emitting device 120 includes a first electrode 121, a second electrode 122, and an organic light emitting layer 123. The first electrode 121 contacts the drain electrode 117.

The organic light emitting layer 123 emits visible rays when a voltage is applied via the first electrode 121 and the second electrode 122.

A pixel defining layer 119 is formed on the first electrode 121. A predetermined opening is formed in the pixel defining layer 119 to expose the first electrode 121. The organic light emitting layer 123 is formed on the exposed first electrode 121. The second electrode 122 is formed to be connected to the organic light emitting layer 123.

The first electrode 121 and the second electrode 122 respectively have polarities of an anode electrode and a cathode electrode. The polarities of the first electrode 121 and the second electrode 122 may be switched.

The sealing substrate 102 is arranged on the second electrode 122.

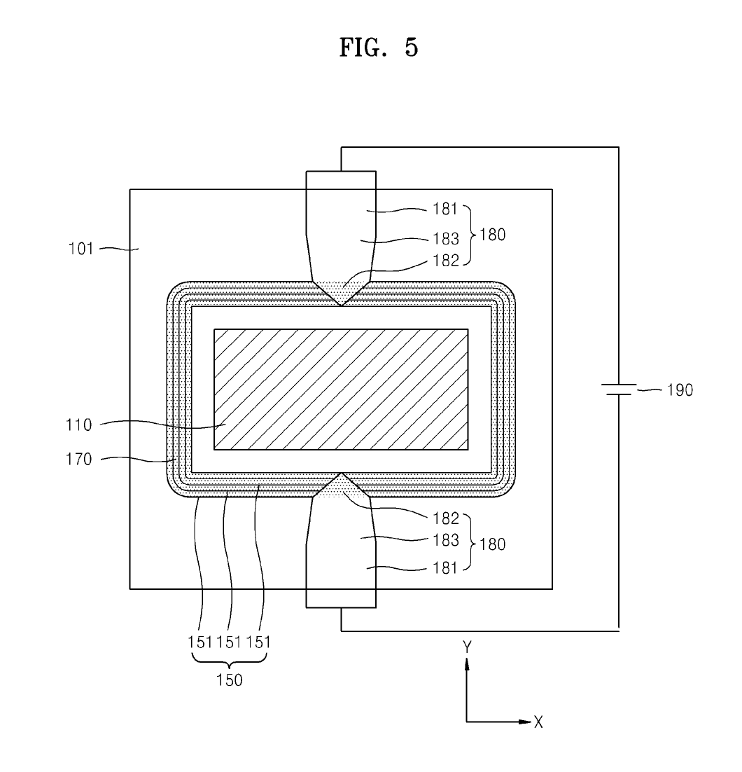

FIG. 5 is a schematic plan view illustrating an operation of forming the sealing member 170 in an embodiment of a process of manufacturing an embodiment of the flat panel display apparatus 100 of FIG. 1. FIG. 5 illustrates applying a voltage from an external power source to form the sealing member 170.

The operation of forming the flat panel display apparatus 100 of FIG. 1 includes a series of operations including an operation of forming the sealing member 170. In the operation of forming the sealing member 170, a material for forming the sealing member 170 is arranged and melted and cured.

In the melting operation, both terminals of an external power source 190 are connected to the main body unit 181 of the leading unit 180. When a voltage is applied, joule heat is generated in the wiring unit 150. Accordingly, the material of the sealing member 170 arranged overlapping with the wiring unit 150 is easily melted and then cured. Also, the material of the sealing member 170 arranged overlapping with the leading unit 180 is melted and cured, thereby forming the sealing member 170. The sealing member 170 facilitates coupling between the substrate 101 and the sealing substrate 102.

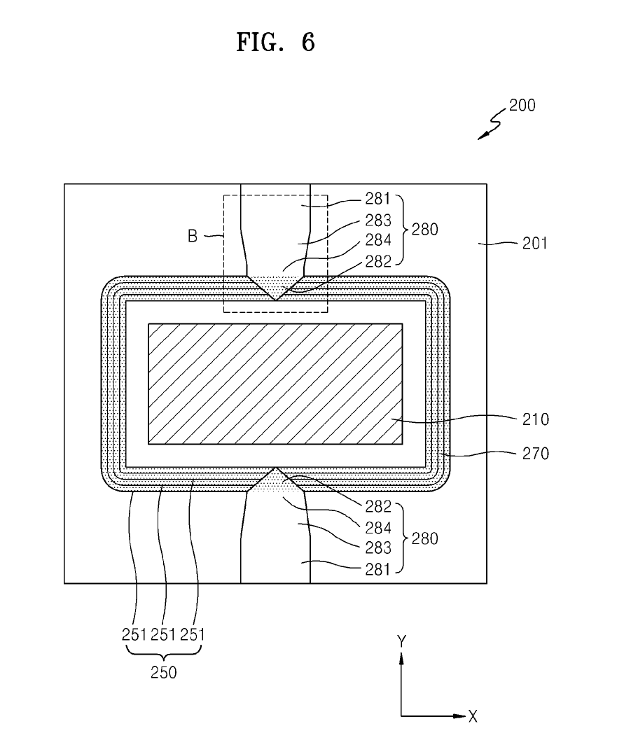

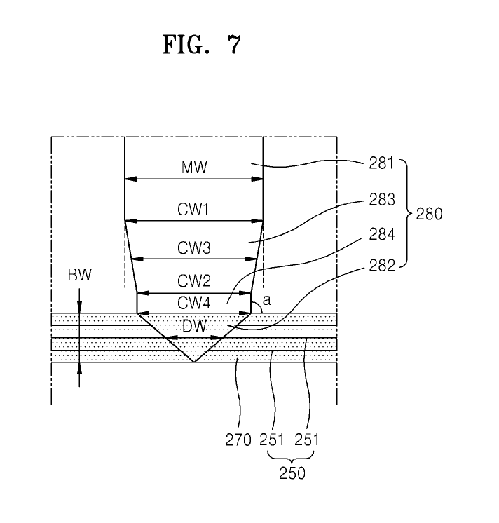

FIG. 6 is a schematic plan view of another embodiment of a flat panel display apparatus 200. FIG. 7 is an enlarged view of portion B of FIG. 6. In FIG. 6, for convenience of explanation, a sealing substrate is not illustrated. Also, for convenience of explanation, a sealing member 270 is indicated as a dotted area in FIGS. 6 and 7.

Referring to FIGS. 6 and 7, the flat panel display apparatus 200 includes a substrate 201, a display unit 210, the sealing substrate (not shown), a wiring unit 250, a sealing member 270, and a leading unit 280. The wiring unit 250 includes a plurality of wiring members 251. The leading unit 280 includes a main body unit 281, a connection unit 282, a first intermediate unit 283, and a second intermediate unit 284. The display unit 210 is arranged on the substrate 201. The substrate 201 may have a variety of shapes in various embodiments. The sealing substrate (not shown) is arranged facing the display unit 210. The sealing member 270 is arranged between the substrate 201 and the sealing substrate. The sealing member 270 surrounds the display unit 210.

The wiring unit 250 is overlapped with the sealing member 270. The wiring unit 250 surrounds the display unit 210. The wiring unit 250 is formed on the substrate 201. The sealing member 270 is formed on the wiring unit 250. The sealing substrate is arranged on the sealing member 270.

The wiring unit 250 includes the wiring members 251. The wiring members 251 are separated from one another in an area overlapped with at least the sealing member 270. Since the structure of the wiring members 251 is the same as that described above in connection with FIG. 1, a detailed description thereof will be omitted herein.

The leading unit 280 is connected to the wiring unit 250. The leading unit 280 is formed on two opposing sides of the wiring unit 250. The leading unit 280 includes the main body unit 281, the connection unit 282, the first intermediate unit 283, and the second intermediate unit 284. The connection unit 282 is connected to the wiring members 251. The main body unit 281 is located farthest from the display unit 210 to be connected to an external power source. The first intermediate unit 283 and the second intermediate unit 284 are arranged between the main body unit 281 and the connection unit 282. One of the wiring members 251 located at the outermost side contacts the connection unit 282 and the second intermediate unit 284.

The main body unit 281 has a predetermined width MW. The width MW of the main body unit 281 may be greater than a width BW of the wiring unit 250. Also, the width MW of the main body unit 281 may be greater than a sum of the widths of the wiring members 251. As described above, the main body unit 281 that is formed to have a width greater than the width BW of the wiring unit 250 prevents excessive generation of heat. When the width of the main body unit 281 is twice greater than the sum of the widths of the wiring members 251, the heat generated by the main body unit 281 and the heat generated by the wiring unit 250 may be similar to each other.

The connection unit 282 is connected to the wiring members 251. The connection unit 282 has a width DW that varies and decreases in a direction away from the main body unit 281. Accordingly, the length of the each of the wiring members 251 may be uniformly controlled so that uniform current may flow in the wiring members 251. As a result, a uniform characteristic of the sealing member 270 may be obtained.

The width CW4 of an end of the connection unit 282 contacting the second intermediate unit 284 may be greater than the width BW of the wiring unit 250 and less than the width MW of the main body unit 281. The connection unit 282 having an area overlapped with the sealing member 270 effectively transfers heat when an external voltage is applied. In some embodiments, the width CW4 of an end of the connection unit 282 may be less than the width MW of the main body unit 281 so that the amount of heat generated in the connection unit 282 is partially greater than that of the main body unit 281. Accordingly, heat is effectively transferred to the area of the sealing member 270 overlapped with the connection unit 282 so that a uniform characteristic of the sealing member 270 may be improved.

Since the connection unit 282 has an integrated structure, when a voltage is applied from the external power source, current stably flows in a whole area of the connection unit 282 overlapped with the sealing member 270 so that a uniform characteristic of the sealing member 270 may be obtained.

The first intermediate unit 283 and the second intermediate unit 284 are arranged between the main body unit 281 and the connection unit 282. The first intermediate unit 283 contacts the main body unit 281 and the second intermediate unit 284 contacts the connection unit 282.

The width CW1 of an end of the first intermediate unit 283 contacting the main body unit 281 is greater than the width CW2 of the other end thereof contacting the second intermediate unit 284. Also, the first intermediate unit 283 has the width CW3 between one end thereof contacting the main body unit 281 and the other end thereof contacting the second intermediate unit 284. The width CW3 decreases away from the main body unit 281 towards the second intermediate unit 284. As the width CW3 of the first intermediate unit 283 gradually changes, current flowing from the main body unit 281 to the connection unit 282 is prevented from abruptly changing.

The second intermediate unit 284 meets the outermost area of the wiring unit 250. The second intermediate unit 284 meets the outermost one of the wiring members 251 located farthest from the display unit 210. The angle “a” (shown in FIG. 7) between the second intermediate unit 284 and the outermost wiring member 251 is designed to be a right angle or an obtuse angle.

When a voltage is applied by a power source during an operation for forming the sealing member 270, current flows between the second intermediate unit 284 and the outermost wiring member 251. When the angle “a” between the second intermediate unit 284 and the outermost wiring member 251 is an acute angle, joule heat may be disproportionally generated in the portion where the angle “a” is formed. To prevent the disproportional generation of joule heat, the angle “a” is formed to be a right angle or an obtuse angle.

An external power source (not shown) may be connected to the main body unit 281 of the leading unit 280. Accordingly, a voltage is applied to the wiring unit 250 so that heat is generated and the sealing member 270 may be formed using the heat. A detailed description is omitted here, since it is the same as that in the above-described embodiment.

The leading unit 280 may be formed of the same material as that of the wiring unit 250. In various embodiments, the display unit 210 may have a variety of shapes and may employ an organic light emitting device or a liquid crystal display device.

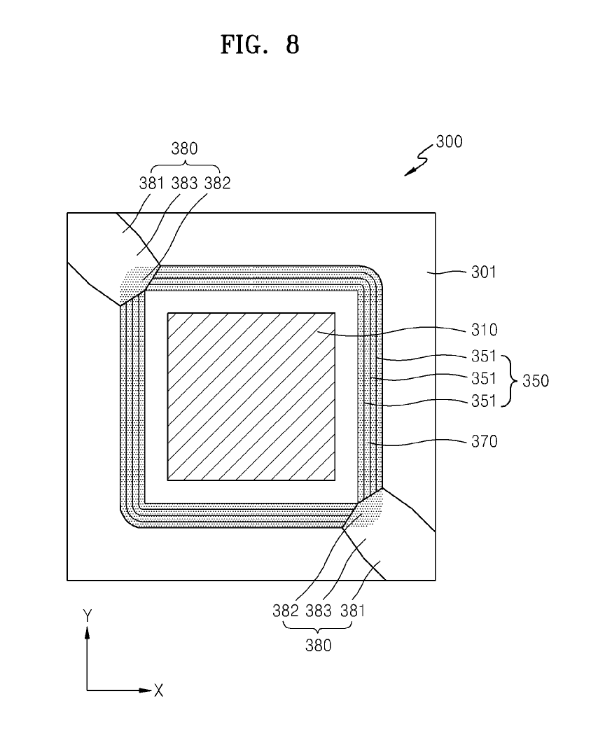

FIG. 8 is a schematic plan view of another embodiment of a flat panel display apparatus 300. In FIG. 8, for convenience of explanation, a sealing substrate is not illustrated. Also, for convenience of explanation, a sealing member 370 is indicated as a dotted area in FIG. 8.

Referring to FIG. 8, the flat panel display apparatus 300 includes a substrate 301, a display unit 310, a sealing substrate (not shown), a wiring unit 350, a sealing member 370, and a leading unit 380. The wiring unit 350 includes a plurality of wiring members 351. The leading unit 380 includes a main body unit 381, a connection unit 382, and an intermediate unit 383.

The display unit 310 is arranged on the substrate 301. The sealing substrate is arranged facing the display unit 310. The sealing member 370 is arranged between the substrate 301 and the sealing substrate to seal the flat panel display apparatus 300. The sealing member 370 surrounds the display unit 310.

The wiring unit 350 is overlapped with the sealing member 370. The wiring unit 350 surrounds the display unit 310. The wiring unit 350 is formed on the substrate 301. The sealing member 370 is formed on the wiring unit 350. The sealing substrate is arranged on the sealing member 370.

The wiring unit 350 includes the wiring members 351. The wiring members 351 are separated from one another in an area overlapped with the sealing member 370. The wiring members 351 may be separated from one another in a whole area.

The leading unit 380 is connected to the wiring unit 350. The leading unit 380 is formed on two opposing corners of the wiring unit 350. The leading unit 380 is formed at two opposing corners on the substrate 301. Since the leading unit 380 is arranged at the corner of the wiring unit 350, a space for arranging an external power source during an operation for forming the sealing member 370 may be reduced.

The leading unit 380 includes the main body unit 381, the connection unit 382, and the intermediate unit 383. The connection unit 382 is connected to the wiring members 351. The main body unit 381 is located farthest from the display unit 310 to be easily connected to the external power source. The intermediate unit 383 is arranged between the main body unit 381 and the connection unit 382. One of the wiring members 351 located at the outermost side contacts the connection unit 382 and the intermediate unit 383.

The connection unit 382 of the leading unit 380 has an area overlapped with the sealing member 370. Also, the intermediate unit 383 has an area overlapped with the sealing member 370. Referring to FIG. 8, the whole area of the connection unit 382 is overlapped with the sealing member 370 and a part of the intermediate unit 383 is overlapped with the sealing member 370.

The main body unit 382 has a predetermined width that is greater than the width of the wiring unit 350. Also, the width of the main body unit 381 is greater than a sum of the widths of the wiring members 351.

The connection unit 382 is connected to the wiring members 351. The connection unit 382 has a width that varies and decreases in a direction away from the main body unit 381.

The width of an end of the connection unit 383 contacting the intermediate unit 383 is greater than the width of the wiring unit 350 and less than the width of the main body unit 381. Since the connection unit 382 has an integrated structure, when a voltage is applied from the external power source, current stably flows in a whole area of the connection unit 382 overlapped with the sealing member 370 so that a uniform characteristic of the sealing member 370 may be obtained.

The intermediate unit 383 is arranged between the main body unit 381 and the connection unit 382. The width of an end of the intermediate unit 383 contacting the main body unit 381 is greater than the width of the other end thereof contacting the intermediate unit 383. The intermediate unit 383 has a width that gradually decreases away from the main body unit 381 towards the intermediate unit 382. As the width of the intermediate unit 383 gradually changes, current flowing from the main body unit 381 to the connection unit 382 is prevented from drastically changing.

An external power source (not shown) may be connected to the main body unit 381 of the leading unit 380. As such, a voltage is applied to the wiring unit 350 so that heat is generated and the sealing member 370 may be formed using the heat. A detailed description is omitted here as it is the same as that in the above-described embodiment.

The leading unit 380 may be formed of the same material as that of the wiring unit 350. In some embodiments, the display unit 310 may have a variety of shapes and may employ an organic light emitting device or a liquid crystal display device.

As described above, embodiments of the flat panel display apparatus and the method of manufacturing a flat panel display apparatus may easily improve an encapsulation characteristic.

While this invention has been particularly shown and described with reference to certain embodiments thereof, it will be understood by those skilled in the art that various changes in form and details may be made therein without departing from the spirit and scope of the invention as defined by the appended claims.

What is claimed is:

1. A flat panel display apparatus comprising:
a substrate;
a display unit on the substrate;
a sealing substrate facing the display unit;
a sealing member between the substrate and the sealing substrate surrounding the display unit;
a wiring unit between the substrate and the sealing substrate with an area overlapped with the sealing member, the wiring unit comprising a plurality of separate wiring members; and
a leading unit comprising a main body unit, a connection unit, and an intermediate unit, wherein the main body unit, the connection unit and the intermediate unit are integrally formed and wherein the leading unit is configured to receive a voltage applied to the wiring unit from an external power source,
wherein the connection unit is connected to the wiring unit, the main body unit is connected to the external power source, the intermediate unit is arranged between the connection unit and the main body unit, and a width of the connection unit decreases away from the main body unit.

2. The flat panel display unit of claim 1, wherein a width of an end of the connection unit contacting the intermediate unit is greater than a width of the wiring unit and less than a width of the main body unit.

3. The flat panel display unit of claim 1, wherein the main body unit has a width greater than a width of the wiring unit.

4. The flat panel display unit of claim 1, wherein the main body unit is located farthest from the display unit in an area of the leading unit.

5. The flat panel display unit of claim 1, wherein the connection unit has an area overlapped with the sealing member.

6. The flat panel display unit of claim 1, wherein the intermediate unit has a width that gradually decreases from an end contacting the main body unit towards an end contacting the connection unit.

7. The flat panel display unit of claim 1, wherein the intermediate unit comprises a first intermediate unit contacting the main body unit and a second intermediate unit contacting the connection unit, and the first intermediate unit has a width that gradually decreases from an end contacting the main body unit towards an end contacting the second intermediate unit.

8. The flat panel display unit of claim 7, wherein the second intermediate unit meets the outermost area of the wiring unit, and an angle between the second intermediate unit and the outermost area of the wiring unit is a right angle.

9. The flat panel display unit of claim 7, wherein the second intermediate unit meets the outermost area of the wiring unit, and an angle between the second intermediate unit and the outermost area of the wiring unit is an obtuse angle.

10. The flat panel display unit of claim 1, wherein the plurality of separate wiring members are separated from one another in a widthwise direction of the sealing member.

11. The flat panel display unit of claim 1, wherein the leading unit is formed along two opposite sides of the substrate a.

12. The flat panel display unit of claim 1, wherein the leading unit is formed to along two opposite corners of the substrate.

13. The flat panel display unit of claim 1, wherein the plurality of separate wiring members are formed on the substrate and the sealing member is arranged on the plurality of separate wiring members in a space between neighboring wiring members.

14. The flat panel display unit of claim 1, wherein the plurality of separate wiring members have curved corner portions.

15. The flat panel display unit of claim 1, wherein the sealing member comprises frit.

16. The flat panel display unit of claim 1, wherein the display unit comprises an organic light emitting device.

17. The flat panel display unit of claim 1, wherein the display unit comprises a liquid crystal display device.

18. A method of a flat panel display unit comprising:
preparing a substrate on which a display unit is arranged;
providing a sealing substrate to face the display unit;
forming a sealing member surrounding the display unit between the substrate and the sealing substrate;
forming a wiring unit comprising a plurality of separate wiring members, and comprising an area overlapped with the sealing member between the substrate and the sealing substrate; and
forming an integrally formed leading unit electrically connected to an external power source, and comprising a main body unit, a connection unit, and an intermediate unit,
wherein the connection unit is connected to the wiring unit, the main body unit is connected to the external power source, the intermediate unit is arranged between the connection unit and the main body unit, and a width of the connection unit decreases away from the main body unit, and
wherein the forming of the sealing member comprises arranging a material for forming the sealing member between the substrate and the sealing substrate, electrically connecting the external power source to the main body unit, applying a voltage to the wiring unit from the external power source, melting and curing the material for forming the sealing member by using heat generated in the wiring unit.

19. The method of claim 18, wherein the sealing member comprises frit.
